(19) United States
(12) Patent Application Publication
(10) Pub. No.: US 2016/0316721 A1
(43) Pub. Date: Nov. 3, 2016

(54) NOVEL ELECTRONIC TOY BALL FOR PETS

(71) Applicant: JIANGSU SLUNGSHOT INFORMATION TECHNOLOGY CO., LTD., Jiangsu (CN)

(72) Inventors: Jin Xie, Jiangsu (CN); Bin Qiu, Jiangsu (CN)

(73) Assignee: JIANGSU SLUNGSHOT INFORMATION TECHNOLOGY CO., LTD., Jiangsu (CN)

(21) Appl. No.: 15/141,822

(22) Filed: Apr. 29, 2016

(30) Foreign Application Priority Data
Apr. 28, 2015 (CN) 201510208484.3

(51) Int. Cl. A01K 15/02; H04N 5/225; H04N 5/44; A01K 29/00; G03B 29/00

(52) U.S. Cl. CPC A01K 15/025; A01K 29/005; G03B 29/00; H04N 5/44; H04N 5/2252; H04N 5/2257; F16H 1/22

(57) ABSTRACT

The invention relates to a novel electronic toy ball for pets, including symmetric left and right hemispherical wheel sleeves (1, 19), wherein the left and right hemispherical wheel sleeves (1, 19) are supported by left and right hemispherical brackets (2, 18), respectively. The hemispherical brackets (2, 18) are internally provided with main ball brackets (13). A pair of centrosymmetric actuating units are fixedly arranged on the main ball bracket (13). The actuating unit includes a motor (16), and the motors (16) drive a front main shaft and a rear main shaft to rotate via transmission gears respectively. The front main shaft and the rear main shaft drive the whole toy ball for pets to roll. The steering of the toy ball for pets is controlled by the rotating speed difference and the rotating direction of the front and rear main shafts. A velometer (speedometer) is fixedly arranged near the motor for measuring the rotating speed of the motor. An infrared element and a camera lens are fixedly arranged on the main ball bracket and are exposed out of the ball. A pet master remotely controls the rolling direction and speed of the toy ball for pet via portable electronic equipment and remotely controls the camera lens for shooting videos or images.

### CROSS-REFERENCE TO RELATED APPLICATIONS

This application claims the priority of Chinese Patent Application No. 201510208484.3, filed on Apr. 28, 2015, the disclosure of which is incorporated by reference in its entirety.

### TECHNICAL FIELD

The present invention relates to a toy for pets, and more particularly, to a novel electronic toy ball for pets, which belongs to the technical field of toys for pets.

### BACKGROUND ART

With improving living standards, more and more people are fond of raising pets, such as pet dogs and pet cats, etc., which are relatively fond of ball toys. The existing pet balls have comparatively simple functions, and pet masters (owners) cannot control the pet balls. When the pet is playing with the ball, it is difficult for the owner to capture pet close-up, while shooting videos or images, and the view of the images or videos is comparatively simple.

### SUMMARY OF THE INVENTION

A technical problem to be solved by the present invention is as follows: the existing pet balls have comparatively simple functions, and pet masters (owners) cannot control the pet balls. When the pet is playing with the ball, it is difficult for the owner to capture the images or videos of the pet close-up, and the view of the images or videos is comparatively simple.

Embodiments of the present invention adopt the following technical solutions:

A novel electronic toy ball for pets includes symmetric left and right hemispherical wheel sleeves 1, 19, wherein the left and right hemispherical wheel sleeves 1, 19 are supported by left and right hemispherical brackets 2, 18, respectively. The hemispherical brackets 2, 18 are internally provided with main ball brackets 13. A pair of centrosymmetric actuating units are fixedly arranged on the main ball brackets 13. The actuating units comprise a pair of motors 16. The pair of motors 16 drive a front main shaft and a rear main shaft to rotate via transmission gears, respectively. The front and rear main shafts drive the whole toy ball for pets to roll. The steering of the toy ball for pets is controlled by the rotating speed difference, and the rotating directions of the front and rear main shafts. A velometer (speedometer) 5 is further fixedly arranged near the motor for measuring the rotating speeds of the motor. An infrared element 12 and a camera may be fixedly arranged on the main ball bracket 13 and are exposed to the outside of the ball. The pet owner can remotely control the rolling directions and speeds of the toy ball for pet via portable electronic equipment and can remotely control the camera to capture videos or images.

In a further embodiment, the novel electronic toy ball for pets may further include a storage battery. In one embodiment, the storage battery may be a rechargeable lithium battery, e.g., a 6V 1000 mA rechargeable lithium battery.

In a further embodiment, the camera may be a 720P high-definition camera.

In a further embodiment, the ball body may be further provided with a power switch.

In a further embodiment, the inside of the novel electronic toy ball for pets may be made of a hard plastic and may be provided with a keel for preventing the internal electronic equipment from being eaten by a pet dog in case the left and right hemispherical wheel sleeves 1, 19 are damaged. The hemispherical sleeves may be made of TPR and can be dismounted and replaced.

In a further embodiment, the electronic toy ball for pets may be self-provided with a PCB electronic integrated control panel, which permits remote control of the motion of the electronic toy ball for pets and the shooting of the camera via a device, e.g., a mobile phone.

In a further embodiment, the electronic toy ball for the pets can transmit video images to the mobile phone of the pet owner in real time.

Embodiments of the present invention may have one or more of the following beneficial effects.
1) having an attractive appearance and special surface design, wherein the left and right hemispherical wheel sleeves play an excellent role in protection and are easily dismounted and replaced;
2) having a good maneuverability, which can move forwards and backwards and steer left and right;
3) being capable of transmitting video images in real time, so that the owner can remotely control a self-balancing ball to find the dog thereof at home;
4) having a special exterior and interior design, which can safely meet the biting of the pet dog, and can replace roller sleeves with ones having different tastes to attract the interest of the pet dogs; and
5) being also a video monitoring equipment for the owner to monitor the environment at home in real time, which increases the possibility of interaction between the owner and the pet dog remotely.

### BRIEF DESCRIPTION OF THE DRAWINGS

FIG. 1 shows an exploded view of a novel electronic toy ball for pets in accordance with one embodiment of the invention.

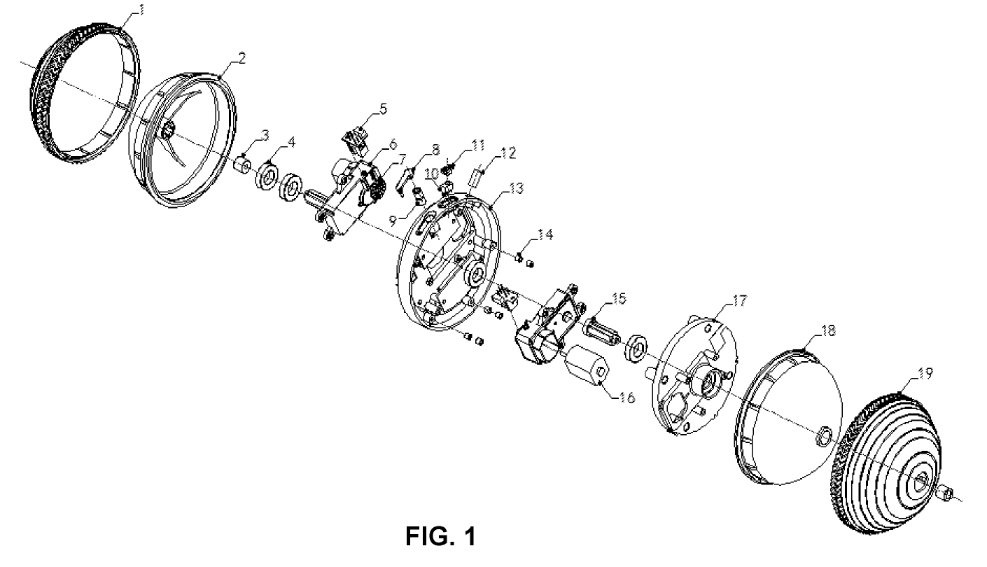

FIG. 2 shows a schematic diagram of actuating units inside the novel electronic toy ball for pets in accordance with one embodiment of the invention.

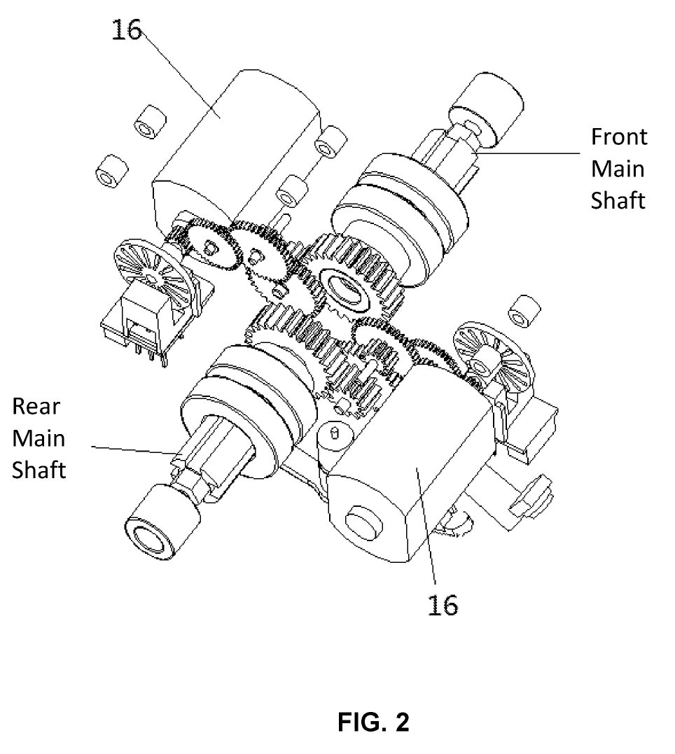

FIG. 3 shows a block diagram for a control principle of a novel electronic toy ball for pets in accordance with one embodiment of the invention.

In the Figs., 1 refers to the left hemispherical wheel sleeve 1; 2 refers to the left hemispherical bracket; 3 refers to a ball fixing column; 4 refers to a bearing; 5 refers to a velometer (speedometer); 6 refers to a driving gearbox; 7 refers to a tachometric wheel; 8 refers to a DC waterproof cover; 9 refers to a DC switch; 10 refers to an ON/OFF switch; 11 refers to an ON/OFF switch cover; 12 refers to an infrared element; 13 refers to a main ball bracket; 14. refers to a rolling POM bearing; 15 refers to a connecting shaft; 16 refers to a motor; 17 refers to a bracket cover; 18 refers to a right hemispherical bracket; and 19 refers to a right hemispherical wheel sleeve.

### DETAILED DESCRIPTION

The present invention will be further descried hereinafter with references to the drawings and exemplary embodiments.

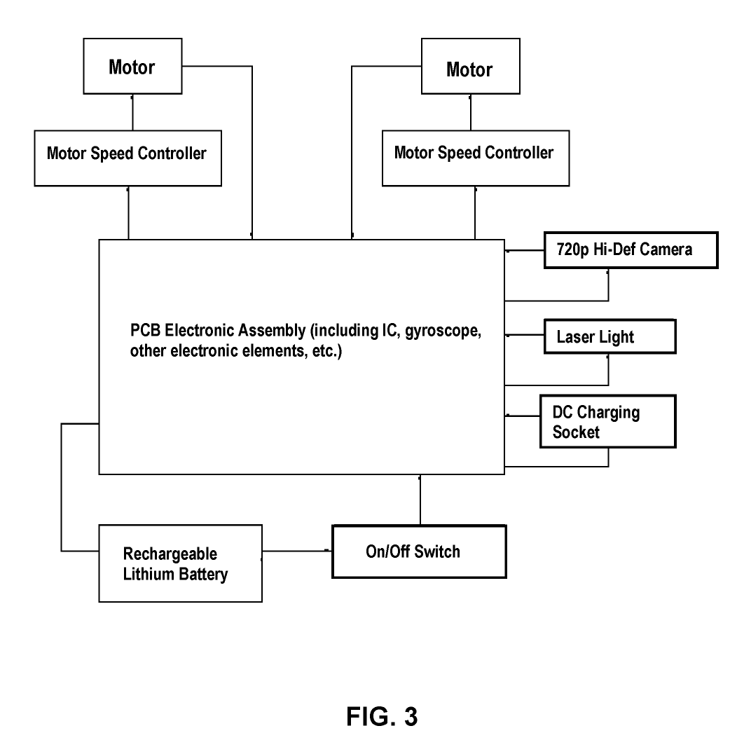

Referring to FIG. 3, a novel electronic toy ball for pets may further include a battery, wherein the battery may be a rechargeable lithium battery, e.g., a 6V 1000 mA rechargeable lithium battery.

The camera may be a 720P high-definition camera.

The ball body may be further provided with a power switch.

The inside of a novel electronic toy ball for pets may be made of a hard plastic and may be provided with a keel for preventing internal electronic equipment from being eaten by a pet dog in case the left and right hemispherical wheel sleeves 1, 19 are damaged. The hemispherical sleeves may be made of a thermoplastic resin (TPR) and can be dismounted and replaced.

An electronic toy ball for pets may be provided with a PCB electronic integrated control panel, which may enable remote control of the motion of the electronic toy ball for pets and the shooting of the camera via a remote device, e.g., a mobile phone.

An electronic toy ball for the pets can transmit video images to the mobile phone of the owner in real time.

An novel electronic toy ball for pets in accordance with embodiments of the invention may have an attractive appearance and special surface design, wherein the left hemispherical wheel sleeve and the right hemispherical wheel sleeve play an excellent role in protection and are easily dismounted and replaced. An novel electronic toy ball for pets in accordance with embodiments of the invention may have a good maneuverability, which can move forwards and backwards and steer left and right. An novel electronic toy ball for pets in accordance with embodiments of the invention be capable of transmitting video images in real time, so that the owner can remotely control a self-balancing ball to find the pet dog thereof at home. An novel electronic toy ball for pets in accordance with embodiments of the invention have a special exterior and interior design, which can safely meet the biting of the pet dog. An novel electronic toy ball for pets in accordance with embodiments of the invention may have roller sleeves that can be replaced with ones having different tastes to attract the interest of the pet dog. An novel electronic toy ball for pets in accordance with embodiments of the invention may also be a video monitoring equipment for the pet owner to monitor the environment at home in real time, which increases the possibility of remote interactions between the owner and the pet dog.

What is claimed is:

1. A novel electronic toy ball for pets, comprising
symmetric left and right hemispherical wheel sleeves, wherein the left and right hemispherical wheel sleeves are supported by left and right hemispherical brackets, respectively, wherein the hemispherical brackets are internally provided with main ball brackets, and wherein a pair of centrosymmetric actuating units are fixedly arranged on the main ball brackets;
the actuating units comprise a pair of motors, the pair of motors drive a front main shaft and a rear main shaft to rotate via transmission gears, respectively, wherein the front and rear main shafts drive the whole toy ball for pets to roll, wherein steering of the electronic toy ball for pets is controlled by a rotating speed difference and rotating directions of the front and rear main shafts, and wherein a speedometer is fixedly arranged near one of the pair of motors for measuring a rotating speed of the one of the pair of motors;
an infrared element and a camera are fixedly arranged on the main ball bracket and are exposed to an outside of the ball such that a pet owner can remotely control the rolling directions and speeds of the toy ball for pet via portable electronic equipment and remotely controls the camera for capturing videos or images.

2. The novel electronic toy ball for pets according to claim 1, further comprising a battery, wherein the battery is a 6V 1000 mA rechargeable lithium battery.

3. The novel electronic toy ball for pets according to claim 1, wherein the camera is a 720P high-definition camera.

4. The novel electronic toy ball for pets according to claim 1, wherein the ball body is further provided with a power switch.

5. The novel electronic toy ball for pets according to claim 1, wherein an inside of the novel electronic toy ball for pets is made of hard plastic and is provided with a keel for preventing internal electronic equipment from being eaten by a pet dog in case the left and right hemispherical wheel sleeves (1, 19) are damaged; and the hemispherical sleeves are made of TPR and can be dismounted and replaced.

6. The novel electronic toy ball for pets according to claim 1, wherein the electronic toy ball for pets is self-provided with a PCB electronic integrated control panel, which remotely enables and controls the motion of the electronic toy ball for pets and the shooting of the camera lens via a mobile phone.

7. The novel electronic toy ball for pets according to claim 6, wherein the electronic toy ball for the pets can transmit video images to the mobile phone of the master in real time.
